(19) United States
(12) Patent Application Publication
(10) Pub. No.: US 2010/0221174 A1
(43) Pub. Date: Sep. 2, 2010

(54) SYSTEMS AND METHODS FOR HYDROGEN AND ELECTRICITY GENERATION

(76) Inventors: Lawrence CLAWSON, Dover, MA (US); Michael Leshchiner, Needham, MA (US); Darryl Pollica, Melrose, MA (US); Atul Sharma, Billerica, MA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/555,336

(22) Filed: Sep. 8, 2009

Related U.S. Application Data
(60) Provisional application No. 61/136,444, filed on Sep. 5, 2008.

(51) Int. Cl. C01B 3/24; F02B 43/00

(52) U.S. Cl. 423/650; 123/3

(57) ABSTRACT

This disclosure related to systems and methods that produce hydrogen and electricity from hydrocarbon fuels.

This application claims the benefit of U.S. Provisional Application No. 61/136,444, filed Sep. 5, 2008.

The present disclosure is directed to systems and methods that generate hydrogen and electricity from hydrocarbon fuels.

Steam reforming is the method of choice for producing hydrogen from hydrocarbons, such as methane. One of the challenges in steam reforming is that a large amount of energy must be transferred from an external source into the steam reformer to sustain the reaction. Therefore, the steam reforming reaction is affected by practical limitations including the heat transfer rate and the reaction temperature. The latter affects conversion equilibrium and reaction kinetics. High reaction temperatures in the reformer correspond to higher reaction rates, higher hydrocarbon conversions, and a lower amount of residual hydrocarbons in reformate. However, higher reaction temperatures may cause severe thermal stresses and corrosions to the reformer itself. Conversely, lower reaction temperatures in the reformer may lead to lower hydrocarbon conversions and a higher amount of unreacted hydrocarbons in the product mix, commonly referred to as reformate. The more hydrocarbons left unreacted, the less efficient the steam reformer system becomes.

Large scale industrial steam reformers often have bundles of reactor tubes surrounded by “impingement” style burner modules, from which a burner fuel-air mixture is fired directly toward the reactor tubes. Such steam reformers operate at very high reaction temperatures and run continuously with few startup-shutdown cycles. However, a smaller scale hydrogen generator produces relatively small quantities of hydrogen. Its operation is affected by the fluctuations in the demand for hydrogen and often involves startup-shutdown cycles of the reformer. Frequent startup-shutdown cycles may cause temperature spikes and hot spots in the reformer, which exerts high thermal stresses and can cause metal fatigue failures in a relatively short period of time. There is a need for systems and methods that enable the low temperature operation of the steam reformer as well as low hydrocarbon emission from the system. The current disclosure provides systems and methods to achieve this goal.

This disclosure provides a system for generating hydrogen. The system comprises a source of a hydrocarbon fuel, a steam reformer wherein the hydrocarbon fuel is converted to a hydrogen-containing reformate, a pressure swing absorber connected with the steam reformer wherein the reformate is separated into purified hydrogen and raffinate, and an internal combustion engine consuming a combustible mixture comprising the raffinate and air. The amount of air supplied to the engine is less than the amount of air required to completely oxidize the combustible mixture.

This disclosure also provides a method of producing hydrogen. The method comprises the steps of partially combusting a combustible mixture in an internal combustion engine to produce an engine exhaust, steam reforming a hydrocarbon fuel in a steam reformer to produce a hydrogen-containing reformate, and purifying the hydrogen-containing reformate in a pressure swing absorber to produce purified hydrogen and raffinate.

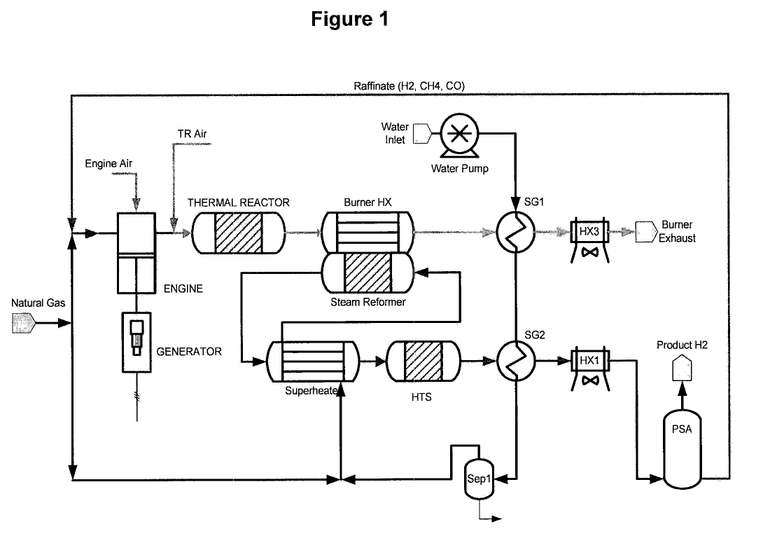

FIG. 1 is a schematics of a system that generates hydrogen and electricity.

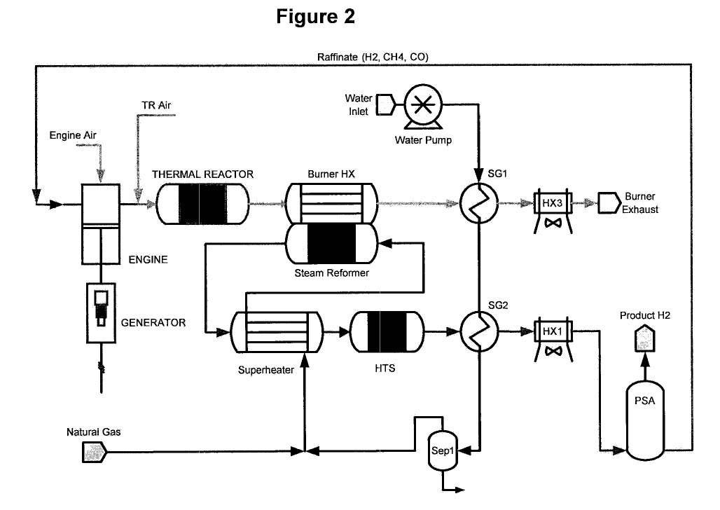

FIG. 2 is a schematics of another system that generates hydrogen and electricity.

In a system shown in FIG. 1, natural gas feed stock splits into two streams. One stream is first combined with water in the form of steam. The natural gas/steam mixture is preheated in a superheater before entering the steam reformer, where the mixture is converted to a hydrogen-containing reformate. The reformate exiting the steam reformer then enters the superheater, where the reformate is cooled by the natural gas/steam mixture. The reformate further enters a high temperature shift reaction (HTS), where carbon monoxide in the reformate reacts with steam to form hydrogen and carbon dioxide.

The reformate from the HTS, after cooling in a heat exchanger, enters a pressure swing absorber (PSA). The pressure swing absorber separates hydrogen from the reformate to form a product hydrogen stream (the purity of the product hydrogen can reach higher than 99.9%) and a raffinate stream, which comprises hydrogen, unreacted hydrocarbons, and carbon monoxide.

The raffinate stream, optionally combined with another stream of natural gas, provides fuel to an Otto-cycle engine. The engine drives a generator which generates electricity to power the system, or to connect to other electrical loads or to the grid. In this system, the engine is running rich, meaning that the ratio of fuel to air is higher than the stoichiometric value so that there is not enough air in the engine to completely oxidize the fuel. The exhaust from the engine, still containing unreacted fuel, enters a thermal reactor where it further combusts to completely consume the residual combustibles in the exhaust. Optionally, additional air (TR air) may be provided to the thermal reactor for the complete combustion of the hydrocarbons. The exhaust from the thermal reactor enters a burner/heat exchanger (burner HX) in which it supplies heat to the steam reformer. The exhaust, after further cooling, vents to the air.

One embodiment of a system in this disclosure is that the internal combustion engine can be fueled solely by the raffinate from the pressure swing absorber. A schematic of such a system is shown in FIG. 2, in which only the raffinate stream is the fuel in the internal combustion engine.

One aspect of the embodiment of the system in this disclosure is that about two thirds of the combustibles in the engine are consumed, leaving about one third for further combustion in the thermal reactor. The heat carried in the exhaust from the thermal reactor is sufficient to sustain the steam reforming reaction.

Another aspect of the embodiment of the system in this disclosure is that a separate blower or an air compressor to pump air into the otherwise naturally aspirated Otto-engine. Alternatively, the engine can be equipped with a turbo charger. Using a turbo charger may increase the efficiency of a system having a relatively large hydrogen production capacity, such as 500 kg/day or more, by allowing the system to use a lower displacement, smaller engine. Such a turbo-charger also can provide air to both the engine and the thermal reactor.

A further aspect of the embodiment of the system in this disclosure is that combusting the engine exhaust in the thermal reactor will raise the temperature of the exhaust, for example, from about 600° C. to about 1200° C., including about 900° C. to about 1100° C. From there the hot exhaust gas that can have a relatively uniform temperature enters the burner-heat exchanger to provide the required energy for the steam reforming reaction. Thus, the exhaust from the thermal reactor supplies heat to the steam reformer, and this heat can have a relatively uniform temperature. In certain embodiments, the relatively uniform temperature stream entering the burner-heat exchanger reduces metal stresses found characteristically with other burner designs. Afterwards, the residual heat in the exhaust can be used to generate steam.

In certain embodiments, the system further comprises a power generator driven by the internal combustion engine. The power produced in the power generator is at least partially consumed in the system.

In another embodiment, the Otto-cycle engine may drive a compressor to compress the product hydrogen for storage.

In a further embodiment, the Otto-cycle engine may run lean, meaning there is more than enough air in the engine for the complete consumption of the fuel.

In still another embodiment, the system only produces electricity when hydrogen is not needed, for instance, when the hydrogen storage reaches its capacity. In that case, reformate may be supplied as fuel to the engine, which in turn drives the generator to produce electricity.

In yet another embodiment, reformate from the steam reformer may enter the PSA without first experiencing a high temperature water gas shift reaction, since CO in the reformate can be eventually consumed in the engine or the thermal reactor.

Advantages of running the engine rich over running the engine lean can include, for example, increased engine operation stability, higher engine specific power, and lower NOx emissions. Lower NOx emissions can be realized because carbon monoxide generated in rich combustion process competes against nitrogen for oxygen. Higher engine specific power can be achieved because rich combustion generates a denser exhaust which increases engine torque, MEP, or power.

Further, this system can be used to dispense compressed natural gas to a vehicle when necessary, i.e., to function as a natural gas fueling station. Under this operation mode, a high pressure natural gas compressor, a natural gas dispenser, and optionally a natural gas storage are needed. When grid power is available, the natural gas compressor can be powered off the grid power. If the grid power is not available, for instance, in a remote area, the compressor may be driven by the engine, which uses the reformate or natural gas as the fuel. Alternatively, the compressor or the PSA can be powered by electricity produced within the system, for example, by the power generator.

In certain embodiments directed to a method of producing hydrogen, the method may also include the step of oxidizing the engine exhaust in a thermal reactor so that the temperature of an exhaust gas from the thermal reactor ranges from about 600° C. to about 1200° C. This exhaust gas is further used to supply heat to the steam reformer.

The method may further include the step of producing electricity in a power generator driven by the internal combustion engine. The electricity produced in the power generator may be used to power an electrical load in the system, including an air blower, an air compressor, a turbo-charger, a hydrogen compressor, a natural gas compressor, or a pressure swing absorber. In such embodiments, at least a portion of the electricity consumed in the system would thus be produced by the power generator driven by the internal combustion engine.

We claim:

1. A system for generating hydrogen, comprising:
a source of a hydrocarbon fuel;
a steam reformer wherein the hydrocarbon fuel is converted to a hydrogen-containing reformate;
a pressure swing absorber connected with the steam reformer wherein the reformate is separated into purified hydrogen and raffinate; and
an internal combustion engine consuming a combustible mixture comprising the raffinate and air, wherein an amount of air in the engine is less than an amount required to completely oxidize the combustible mixture.

2. The system of claim 1, further comprising:
a thermal reactor wherein an exhaust from the internal combustion engine is further oxidized.

3. The system of claim 2, wherein the temperature of the exhaust gas from the thermal reactor ranges from about 600° C. to about 1200° C.

4. The system of claim 3, wherein the temperature of the exhaust gas from the thermal reactor ranges from about 900° C. to about 1100° C.

5. The system of claim 3, further comprising a heat exchanger coupled with the steam reformer, wherein the exhaust gas from the thermal reactor passes through the heat exchanger and transfers energy to the steam reformer.

6. The system of claim 1, further comprising a power generator driven by the internal combustion engine.

7. The system of claim 1, wherein the combustible mixture further comprises hydrocarbon fuel.

8. The system of claim 1, further comprising a high temperature shift reactor in which the carbon monoxide in the reformate from the steam reformer is oxidized.

9. The system of claim 1, wherein the internal combustion engine is an Otto-cycle engine.

10. The system of claim 1, wherein the air to the internal combustion engine is supplied by a blower, a compressor, or a turbo-charger.

11. The system of claim 6, wherein at least a portion of the electricity consumed in the system is produced by the power generator driven by the internal combustion engine.

12. A method of producing hydrogen, comprising:
partially combusting a combustible mixture in an internal combustion engine to produce an engine exhaust;
steam reforming a hydrocarbon fuel in a steam reformer to produce a hydrogen-containing reformate; and
purifying the hydrogen-containing reformate in a pressure swing absorber to produce purified hydrogen and raffinate.

13. The method of claim 12, further comprising:
oxidizing the engine exhaust in a thermal reactor so that the temperature of an exhaust gas from the thermal reactor ranges from about 600° C. to about 1200° C.

14. The method of claim 13, wherein the temperature of the exhaust gas form the thermal reactor ranges from about 900° C. to about 1100° C.

15. The method of claim 14, wherein the exhaust gas from the thermal reactor transfers heat to the steam reformer.

16. The method of claim 12, wherein the internal combustion engine is an Otto-cycle engine.

17. The method of claim 12, further comprising:
producing electricity in a power generator driven by the internal combustion engine.

8. The method of claim 1, wherein the combustible mixture comprises a hydrocarbon fuel, the raffinate from the pressure swing absorber, and air.

9. The method of claim 17, wherein the air is supplied to the internal combustion engine using an air blower, a compressor, or a turbo-charger.

20. The method of claim 12, wherein the internal combustion engine drives a hydrogen compressor, which compresses the purified hydrogen from the pressure swing absorber.

21. The method of claim 12, wherein the internal combustion engine drives a natural gas compressor.

22. The method of claim 17, wherein at least a portion of the electricity consumed in the system is produced by the power generator driven by the internal combustion engine.
